(19) United States
(12) Patent Application Publication
(10) Pub. No.: US 2011/0089119 A1
(43) Pub. Date: Apr. 21, 2011

(54) TREATMENT ADDITIVES AND METHODS FOR TREATING AN AQUEOUS MEDIUM

(76) Inventors: Gerald C. WALTERICK, JR., Levittown, PA (US); William S. Carey, Wallingford, PA (US); Fang Deng, Phoenix, AZ (US)

(21) Appl. No.: 12/975,986

(22) Filed: Dec. 22, 2010

Related U.S. Application Data
(62) Division of application No. 12/171,605, filed on Jul. 11, 2008.

(51) Int. Cl. C02F 1/56

(52) U.S. Cl. 210/736

(57) ABSTRACT

A method for clarifying an aqueous medium containing suspended material is provided. The method includes dispersing a treatment additive in the aqueous medium containing the suspended material for coagulating and flocculating the suspended material and then separating the suspended material from the treated aqueous medium. The treatment additive includes a crosslinked diallyldialkylammonium halide polymer having from about 0.001 molar percent to less than 0.1 molar percent of a crosslinking agent. A treatment additive composition is also provided.

### CROSS REFERENCE TO RELATED APPLICATIONS

This application is a divisional application of U.S. patent application Ser. No. 12/171,605, filed on Jul. 11, 2008 (published as U.S. Patent Application Publication No. 2010-0006511-A1 on Jan. 14, 2010), and claims the associated benefit under 35 U.S.C. §120 and 35 U.S.C. §121. The entire contents of parent U.S. patent application Ser. No. 12/171,605, entitled “TREATMENT ADDITIVES AND METHODS FOR TREATING AN AQUEOUS MEDIUM”, are hereby incorporated by reference in their entirety.

### FIELD OF THE INVENTION

This invention relates to methods and treatment additives for treating aqueous media and more particularly, to methods and treatment additives for clarifying aqueous media.

### BACKGROUND OF THE INVENTION

Raw water, such as water from rivers, lakes or underground sources, usually contains suspended matter. The suspended matter must be removed to provide suitable water for use in domestic and industrial applications. The suspended matter may contain large solids that are easily removed by settling, and other suspended materials that are not easily removed by settling and are often colloidal in nature. The suspended materials are typically removed by clarification, which includes the steps of coagulation, flocculation and sedimentation. Naturally occurring suspended particles are predominantly negatively charged and are typically removed with water-soluble organic cationic polymers, such as polydiallyldimethyl ammonium chloride (Klaraid® PC1192P available from GE Betz, Inc. or PRP 4420 from Pearl River Polymers, Inc.).

It would be desirable to provide improved clarification methods for removing suspended material from aqueous media.

### SUMMARY OF THE INVENTION

In one embodiment, a method for clarifying an aqueous medium containing suspended material, said method comprising dispersing a treatment additive in the aqueous medium containing the suspended material for coagulating and flocculating the suspended material and then separating the suspended material from the treated aqueous medium, said treatment additive comprising a crosslinked diallyldialkylammonium halide polymer having from about 0.001 molar percent to less than 0.1 molar percent of a crosslinking agent.

In another embodiment, a treatment additive composition consists of the reaction product of:

(a) diallyldialkylammonium halide;

(b) from about 0.001 molar percent to less than 0.1 molar percent of a crosslinking agent based on the crosslinked polymer;

(c) an initiator; and

(d) optionally, a chelating agent.

The various embodiments provide improved methods for coagulating and flocculating suspended material in aqueous media and for clarifying aqueous media.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

In one embodiment, a method for clarifying an aqueous medium containing suspended material, said method comprising dispersing a treatment additive in the aqueous medium containing the suspended material for coagulating and flocculating the suspended material and then separating the suspended material from the treated aqueous medium, said treatment additive comprising a crosslinked diallyldialkylammonium halide polymer having from about 0.001 molar percent to less than 0.1 molar percent of a crosslinker.

The aqueous medium to be treated may be any kind of aqueous medium having suspended material. In one embodiment, the aqueous medium is water. In another embodiment, the aqueous medium is wastewater or raw water from rivers, lakes or underground sources. Wastewater may include primary and oily wastewater streams from refineries, petrochemical industries, chemical industries, steel industries, rolling mill industries, automobile industries, textile industries, and meat and food processing industries.

The suspended materials are organic or inorganic solids suspended or dispersed in the aqueous medium and may be debris, organic matter, such as fatty and proteinaceous substances, oil, grease, oily waste, precipitated metals, suspended clay, mud or silt. The suspended materials may contain large solids and other suspended particulate material, which may be colloidal in nature.

The treatment additive is a cationic and water soluble, crosslinked polymer that coagulates and flocculates the suspended material in the aqueous medium. Naturally occurring suspended particles are predominantly negatively charged. Coagulation is the process of neutralizing the charge on the suspended material. Once neutralized, particles no longer repel each other and can be brought together. Flocculation is the process of coalescing the neutralized or coagulated materials to form a larger agglomeration or floc. The agglomeration is then separated from the aqueous medium to clarify and purify the aqueous medium.

In one embodiment, the treatment additive is a crosslinked polydiallyldialkylammonium halide. The alkyl group may be a C₁-C₁₀ alkyl group. In another embodiment, the alkyl group may be methyl, ethyl, propyl or butyl. In one embodiment, the halide is chloride, bromide or iodide. In another embodiment, the treatment additive is crosslinked polyldiallyldimethylammonium chloride (poly-DADMAC).

The diallyldialkylammonium halide may be crosslinked with any suitable crosslinker. In one embodiment, the diallyldialkylammonium chloride is crosslinked with tri-allylammonium chloride (A₃ACl) or tetraallylammonium chloride (A₄ACl).

In one embodiment, the treatment additive has structure I or structure II:

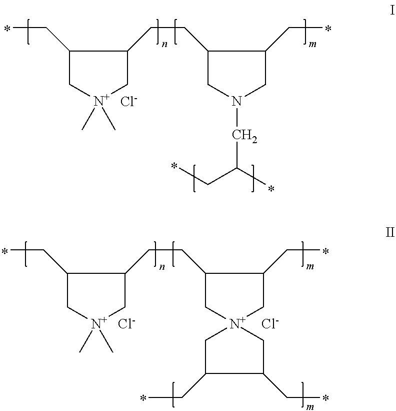

wherein m is from about 10 to about 100 and n is from about 1000 to about 1,000,000.

The crosslinked diallyldialkylammonium halide may be prepared by aqueous solution polymerization of diallyldialkylammonium halide in the presence of a crosslinking agent and an initiator. The initiator may be a persulfate, azobisisobutyronitrile, oxygen with sodium sulfite or sodium metabisulfite, 2,2-azobis(2-methyl-2-amidinopropane) dihydrochloride, ammonium persulfate or ferrous ammonium sulfate hexahydrate. In one embodiment, the temperature for the reaction is from about 25° C. to about 150° C. In another embodiment, the reaction time is from about 1 to about 5 hours.

Conventional additives may be added to the reaction to promote the reaction or enhance the yield of the crosslinked diallyldialkylammonium halide. In one embodiment, a chelating agent may be added to complex with metals in the reaction that might inhibit polymerization. In one embodiment, the chelating agent is diethylenetriamine pentaacetic acid sodium salt.

In one embodiment, the chelating agent may be added in an amount of from about 0.05 to about 10 percent by weight based on the weight of the diallyldialkylammonium halide. In another embodiment, the chelating agent may be added in an amount of from about 0.1 to about 5 percent by weight based on the weight of the diallyldialkylammonium halide.

The crosslinking agent is present from about 0.001 molar percent to less than 0.1 molar percent based on the crosslinked polymer. In another embodiment, the crosslinking agent is present from about 0.001 molar percent to about 0.09 molar percent based on the crosslinked polymer. In another embodiment, the crosslinking agent is present from about 0.0025 to about 0.08 molar percent based on the crosslinked polymer. In another embodiment, the crosslinking agent is present from about 0.005 to about 0.05 molar percent based on the crosslinked polymer.

In one embodiment, the amount of initiator is from about 2 percent by weight to about 3 percent by weight based on the weight of the diallyldialkylammonium halide.

The crosslinked diallyldialkylammonium halide has a weight average molecular weight in the range from about 5000 to about 800,000 amu. In another embodiment, the weight average molecular weight is from about 100,000 to about 500,000 amu. The intrinsic viscosity is from about 500 to about 2500 centipoise.

The treatment additive is dispersed in the aqueous media in any conventional manner. In one embodiment, the treatment additive is added to the aqueous medium and mixed until dissolved. In another embodiment, the treatment additive is vigorously agitated with the aqueous medium. In one embodiment, the treatment additive is mixed with the aqueous medium from about 10 seconds to about 5 minutes.

The treatment additive is added in any amount sufficient for clarifying the aqueous medium. In one embodiment, the treatment additive is added in an amount of from about 1 ppm to about 10 ppm by weight based on the weight of the aqueous medium.

The coagulated material is separated from the treated aqueous medium by any conventional manner. In one embodiment, the coagulated material settles out of the aqueous medium. In another embodiment, the coagulated material is separated from the aqueous medium by filtration.

In another embodiment, a treatment additive composition consists of the reaction product of:

(a) diallyldialkylammonium halide;

(b) from about 0.001 molar percent to less than 0.1 molar percent of a crosslinking agent based on the crosslinked polymer;

(c) an initiator; and

(d) optionally, a chelating agent.

The diallyldialkylammonium halide polymer, the crosslinking agent, chelating agent and initiator are described above.

In order that those skilled in the art will be better able to practice the present disclosure, the following examples are given by way of illustration and not by way of limitation.

### EXAMPLES

### Example 1

To a 300 ml four-necked reaction flask equipped with a mechanical overhead stirrer, thermocouple, reflux condenser, nitrogen sparge tube, addition port with septum and a heating mantle, was added diallyldimethyl ammonium chloride (100 g, 65% aqueous solution), tetraallylammonium chloride (A₄ACl) (50 ppm on a molar basis), diethylenetriamine pentaacetic acid sodium salt (0.1 g, 40% aqueous solution) and deionized water (150 g). The resulting solution was then heated to 80° C. under nitrogen sparge with mixing. 5 ml of an initiator solution (3 grams of ammonium persulfate dissolved in 20 ml of deionized water) was then charged to the reactor and the batch was held at 80° C. for one hour. A second 5-ml aliquot of the initiator solution was then added to the reactor and the batch was held at 80° C. for one hour. The remainder of the initiator solution was then added to the reactor and the batch was held at 80° C. for one hour. After the hold, the batch was adjusted to 18 wt. % actives with deionized water and cooled to room temperature to yield a clear viscous aqueous solution with a bulk viscosity of 865 cps.

### Example 2

Example 2 was prepared in accordance with Example 1, except 25 ppm on a molar basis of A₄ACl was used.

### Example 3

Example 3 was prepared in accordance with Example 1, except 100 ppm on a molar basis of A₄ACl was used.

The physical characterizations of Examples 1-3 and Comparative Examples (CE-A-1, CE-A-2, CE-B, CE-C and CE-D) are summarized in Table 1.

TABLE 1

| | Cross- | | % | Viscosity |
|---|---|---|---|---|
| Applications Notation | Linker | ppm | Solids | (cps) |
| Example 1 | A₄ACl | 50 | 18.8 | 865 |
| Example 2 | A₄ACl | 25 | 18.2 | 136 |
| Example 3 | A₄ACl | 100 | 13.1 | 114 |
| CE-A-1 | None | N/A | 18.0 | 310 |
| (Klaraid ® PC1192P) | | | | |
| CE-A-2 | None | N/A | 18.0 | 310 |
| (Klaraid ® PC1192P) | | | | |
| CE-B | None | N/A | 21.0 | |
| (PRP 4420) | | | | |
| CE-C | None | N/A | 21.0 | |
| (PRP 4520) | | | | |
| CE-D | None | N/A | 21.0 | |
| (PRP 4620) | | | | |

### Example 4

To demonstrate the water clarification efficacy of the Examples 1-3, evaluations were conducted using two lab-prepared river waters as test substrates. Both substrates contained deionized water, reagent grade chemicals, naturally occurring clays and humic acid.

The first substrate, designated Synthetic Lower Neches Valley Authority (LNVA) River Water, was prepared to closely approximate the composition of a typical medium turbidity river and has the following composition:

Turbidity=99.5-100 ntu

Total suspended solids=300 mg/liter

True color=185-186 Pt—Co color units

pH=6.75-6.78

Ca=20 mg/liter as CaCO₃

Mg=10 mg/liter as CaCO₃

The second substrate, designated Synthetic Mississippi River Water, was prepared to approximate the composition of a high turbidity, high hardness river and has the following composition:

Turbidity=198-220 ntu

Total suspended solids=457 mg/liter

True color=152-157 Pt—Co color units

pH=7.47-7.52

Ca=100 mg/liter as CaCO₃

Mg=51 mg/liter as CaCO₃

The procedure used for these evaluations was a standard jar test procedure designed to simulate the operation of a typical full-scale water treatment clarifier. The relative water clarification efficacy of each polymer was determined by measuring the residual turbidity and residual true color remaining in the water after treatment using the procedure described below. Turbidity was measured as an indication of the amount of suspended solids contaminants in the water. True color was measured as an indication of the amount of naturally occurring humic contaminants in the water.

All tests were conducted using a Phipps and Bird 6-Paddle Stirrer equipped with 1″ high×2″ wide paddles. The procedure is described below:
1) 200 ml of test substrate added to 250-ml glass beaker;
2) Polymer solution added to test substrate while mixing substrate @100 rpm;
3) Mixed 2 minutes @100 rpm;
4) Mixed 5 minutes @35 rpm;
5) Mixing stopped, paddle removed, 5 minutes allowed for solids to settle;
6) Supernatant water sampled for analysis;
7) Turbidity of supernatant sample measured using Hach Model 2100AN Turbidimeter;
8) True color of supernatant sample measured using Hach DR/2000 Spectrophotometer.

Results of the water clarification tests for Examples 1-3 and Comparative Examples A-D are given in Tables 2 and 3 below.

TABLE 2
Water Clarification Test Results with Synthetic
LNVA River Water

| | Polymer | Residual | Residual True |
|---|---|---|---|
| Application | Dosage (ppm | Turbidity | Color (Pt-Co |
| Notation | active polymer) | (ntu) | color units) |
| Example 1 | 4 | 2.2 | 31 |
| Example 2 | 4 | 28.0 | 43 |
| Example 3 | 4 | 3.15 | 31 |
| CE-A-1 | 4 | 29.1 | 43 |
| CE-A-2 | 4 | 54.7 | 82 |
| CE-B | 4 | 54.7 | 47 |
| CE-C | 4 | 59.0 | 48 |
| CE-D | 4 | 47.9 | 64 |

TABLE 3
Water Clarification Test Results with Synthetic
Mississippi River Water

| | Polymer | Residual | Residual True |
|---|---|---|---|
| Application | Dosage (ppm | Turbidity | Color (Pt-Co |
| Notation | active polymer) | (ntu) | color units) |
| Example 1 | 2 | 19.5 | 40 |
| Example 2 | 2 | 67.0 | 56 |
| Example 3 | 2 | 21.1 | 45 |
| CE-A-1 | 2 | 89.7 | 52 |
| CE-A-2 | 2 | 98.1 | 64 |
| CE-B | 2 | 115 | 62 |
| CE-C | 2 | 98.3 | 57 |
| CE-D | 2 | 77.7 | 51 |

Examples 1 and 3 were significantly more effective at removing turbidity and resulted in lower true color values than the comparative examples. Example 2 demonstrated better turbidity removal than the comparative examples but was not as effective as Examples 1 and 3, which had higher concentrations of the crosslinking agent.

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

1. A method for clarifying an aqueous medium containing suspended material, said method comprising dispersing a treatment additive in the aqueous medium containing the suspended material for coagulating and flocculating the suspended material and then separating the suspended material from the treated aqueous medium, said treatment additive comprising a crosslinked diallyldialkylammonium halide polymer having from about 0.001 molar percent to less than 0.1 molar percent of a crosslinking agent.

2. The method according to claim 1 wherein the diallyldialkylammonium halide polymer is polydiallyldimethylammonium chloride.

3. The method according to claim 1 wherein the aqueous medium is water.

4. The method of claim 3 wherein the water is wastewater or raw water from rivers, lakes or underground sources.

5. The method of claim 1 wherein the suspended material is organic or inorganic solids.

6. The method of claim 5 wherein the suspended material comprises fatty and proteinaceous substances, oil, grease, oily waste, precipitated metals, suspended clay, mud or silt.

7. The method of claim 1 wherein the alkyl group is a C₁-C₁₀ alkyl group.

8. The method of claim 7 wherein the alkyl group is selected from the group consisting of methyl, ethyl, propyl and butyl.

9. The method of claim 1 wherein the halide is selected from the group consisting of chloride, bromide and iodide.

10. The method of claim 1 wherein the treatment additive has structure I or structure II: 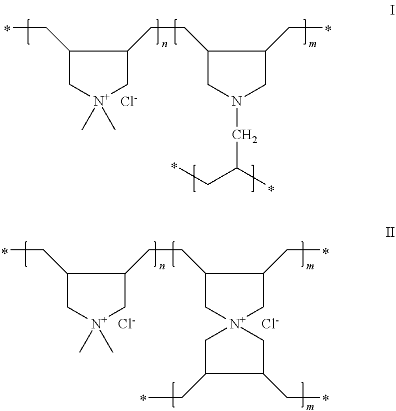
wherein m is from about 10 to about 100 and n is from about 1000 to about 1,000,000.

11. The method of claim 1 wherein the crosslinked diallyldialkylammonium halide has a weight average molecular weight in the range from about 5000 to about 800,000 amu.

12. The method of claim 1 wherein the crosslinked diallyldialkylammonium halide has an intrinsic viscosity from about 500 to about 2500 centipoise.

13. The method of claim 1 wherein the treatment additive is dissolved in the aqueous medium.

14. The method of claim 1 wherein the treatment additive is agitated with the aqueous medium from about 10 seconds to about 5 minutes.

15. The method of claim 1 wherein the treatment additive is added in an amount of from about 1 ppm to about 10 ppm by weight based on the weight of the aqueous medium.

16. The method of claim 1 wherein the coagulated material is separated from the aqueous medium by settling or by filtration.

17. The method of claim 1 wherein the crosslinked diallyldialkylammonium halide has from about 0.001 molar percent to about 0.09 molar percent of a crosslinking agent.
